(19) United States
(12) Patent Application Publication
(10) Pub. No.: US 2006/0064409 A1
(43) Pub. Date: Mar. 23, 2006

(54) Method and system for electronic barter

(75) Inventor: Jessica Hardwick, Cupertino, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Swap Thing, Inc.

(21) Appl. No.: 11/229,950

(22) Filed: Sep. 19, 2005

Related U.S. Application Data
(60) Provisional application No. 60/610,842, filed on Sep. 17, 2004.

(51) Int. Cl. G06F 17/30

(52) U.S. Cl. 707/3

(57) ABSTRACT

Methods and apparatus for receiving user input from a first user specifying items that the first user is offering to trade and items that the first user is seeking to obtain, and receiving user input from a second user specifying items that the second user is seeking to obtain and that the second user is offering to trade. A search operation performed in response to a request from the second user evaluates matches between the items of the first user and the second user. The result of the search operation is displayed to the second user. The displayed search results include items sought by the second user that are also offered by the first user, and items offered by the second user that are also sought by the second user.

### RELATED APPLICATIONS

This application claims priority to and the benefit of U.S. Provisional Application Ser. No. 60/610,842 filed on Sep. 17, 2004. The contents of U.S. Provisional Application Ser. No. 60/610,842 are incorporated herein by reference in their entirety.

### FIELD

Embodiments of the present method and system generally relate to a flexible, computer-implemented system for conducting bartered transactions.

### BACKGROUND

Barter systems are not new. Barter has in fact been one of the oldest forms of commercial transaction where the offered goods or services by one person are traded for the desired goods or services being offered by another. Barter is a time-tested means of exchanging goods and services. For people today, having access to a wide variety of goods and services that can be traded creates a large market, as evidenced by the popularity of garage sales, flea markets and swap meets. One major difficulty in the execution of a barter system, however, is finding a match of someone who wants what another person has and that other person has what that someone wants. This is not necessarily an easy task in the brick and mortar spaces where swap meets tend to be based.

With the advent of the Internet and e-commerce, many one way systems for selling goods on line have proliferated, as exemplified by such Internet sites as e-Bay.com, CraigsList.org, BarterFarm.com, BarterCo.com, BarteritOnline.com, BarterOne.com, TradeAway.com, and the like. The use of the Internet to facilitate the sale of items on line has also been the subject of patents such as U.S. Pat. No. 5,845,265, issued to Thomas Woolston. In none of these online barter systems, however, is it possible to quickly match parties' offers and requirements. For example, with CraigsList, bartered items are posted by date. While a user can query the postings for a particular item sought, there is no quick ready way to match an item sought with what the user may have to offer in trade. Nor is it easy to negotiate on line, to balance the value of the items sought to be traded.

### SUMMARY

Aspects of the present method and system relate to a flexible, on-line, electronic system for conducting barter transactions using an Intelligent Double Matrix™ (IDM) matching system. The IDM search engine matches parties, and facilitates two or multiple-way trades of goods and services. The IDM search engine matches what an on-line user is seeking and identifies other users who are seeking what that user is offering. This is called a double matrix “perfect match.” A user may also perform a search at any time to retrieve a simple result-list of users who have the particular item for swap, regardless of a successful “perfect match.” If a first user wishes to initiate a swap, a second user will be notified by e-mail that a system user wishes to swap with them for a particular item(s) in their swap list, and that the first user may have an item they are seeking.

In addition to providing an on-demand search engine, each system user is assigned an automated “intelligent agent” that will perform this same search periodically. When a perfect match is found, the agent will inform the user/swapper. By way of example only, the user may be informed by displaying the results to the user, at login time, or via separate e-mail, or other user configured method. This automated agent feature is configured to implement search algorithms to determine the results without using excessive server resources. That is, the agents are configured to run at times when the server load is about at a minimal, allowing the system to maximize computing power and server resources. The agent only informs the user/swapper of a match, it does not perform the swap.

The system, in accordance with aspects of the present method and system, provides flexibility, allowing users to swap for goods, services, cash or any combination thereof. Users can set their own price or allow the other user to state what the offered items are worth to them. An Instant Purchase option can be used to bypass the negotiation process and allow users to purchase items and services for a set price. Embodiments of the system described herein offer a national or international venue for exchange. It is available to any entity wishing to barter including but not limited to individuals, small businesses, corporations, non-profit organizations, clubs, collectors and the like, offering both items and services, with no cost to join and low transaction fees.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

Reference is made to the accompanying drawings in which are shown illustrative embodiments of aspects of the invention, from which novel features and advantages will be apparent.

FIG. 1 illustrates a method for identifying and displaying barter exchanges between two users.

FIG. 2 illustrates a method form completing a barter exchange transaction between two users.

FIG. 3 illustrates an electronic system for performing barter exchanges.

FIG. 4 illustrates an exemplary computer architecture for use with the present system, according to one embodiment.

### DETAILED DESCRIPTION

The on line barter system in accordance with aspects of the present method and system provides a complete, flexible barter system that provides the venue for facilitating one-to-one or one-to-many barter exchanges over the Internet. Individuals can optionally register on an Internet site and create lists of items/services they have to offer and items/services they are seeking. Exchanges are generally effectuated between two parties, though they can include a third party or more. The users may propose barter exchanges to other parties for goods, services, cash or a combination of goods, services and/or cash. As included features, users can add as many items, services or both to either side of the exchange by using a “swap wizard” tool. The other party or parties in any exchange may modify the offer by using the same swap wizard tool. All individuals must agree to the elements of the negotiation to complete the transaction. All users exchange directly or indirectly with each other by mail, electronic delivery or personal delivery. Consummation of the swap can be made electronically, by post mail, or personal delivery, and the like. After the trade, individual users rate the other party or parties on the swap to build a reputation within the barter system.

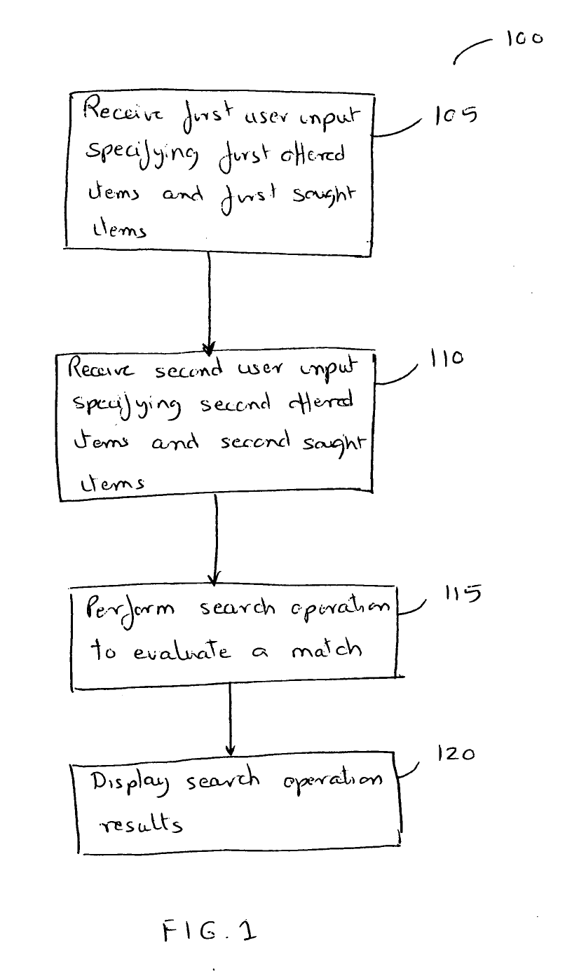

FIG. 1 illustrates a method 100 for identifying and displaying barter exchanges between two users. Input is received from a first user specifying one or more first offered items and one or more first sought items (step 105). The first offered items are items that the first user is offering to trade, and the first sought items are items that the first user is seeking to obtain in exchange for the first offered items. In addition, input is received from a second user specifying one or more second sought items, and one or more second offered items (step 110). The second sought items are items that the second user is seeking to obtain, and the second offered items are items that the second user is offering in exchange for the second sought items. A search operation is performed in response to a request from the second user (step 115), and the search operation results are displayed to the second user (step 120). The search operation evaluates a match between the first user and the second user based on the first offered items, the first sought items, the second offered items and the second sought items.

The displayed search results include three categories of matches—perfect matches, matches showing second sought items that are also being offered by the first user, and matches showing second offered items that are also being sought by the first user. Perfect matches are matches where the first user is offering all of the second sought items, and where the first user is also seeking to obtain at least one of the second offered items. In one implementation the three categories of matches are displayed separately.

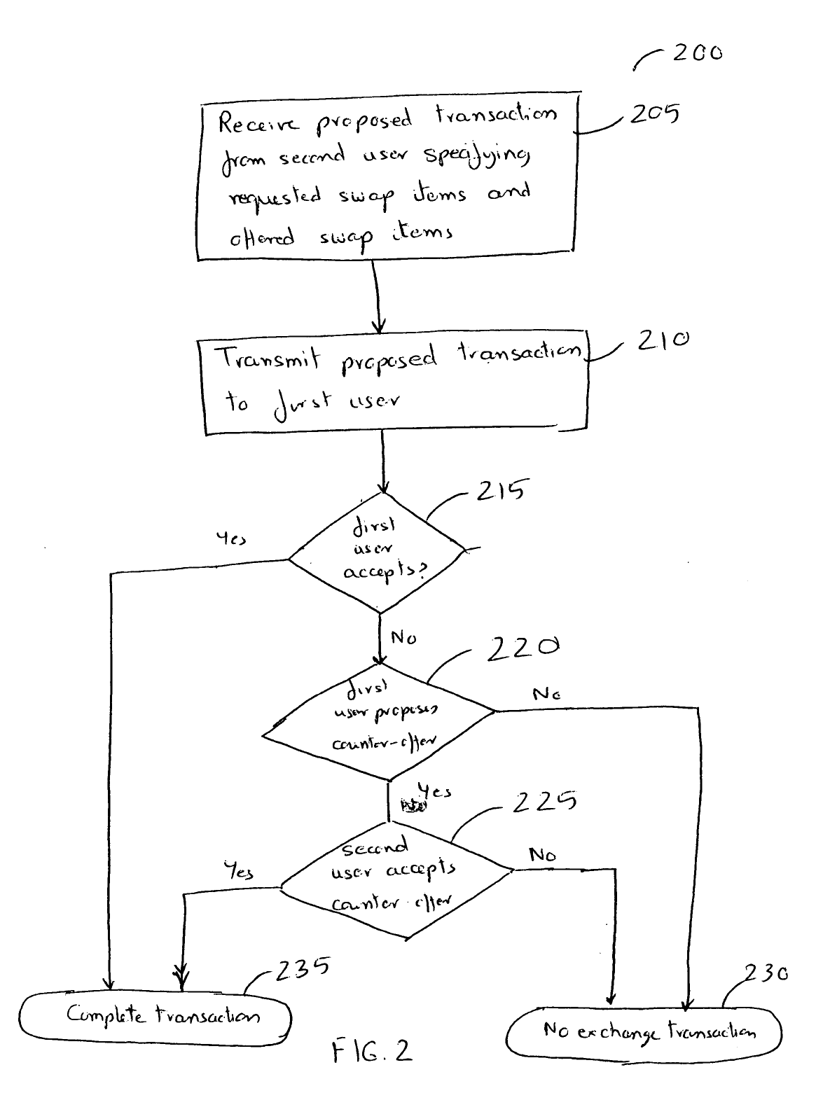

FIG. 2 illustrates a method 200 for completing an exchange transaction between the first user and the second user. A proposed transaction is received from the second user proposing an exchange transaction (step 205). The second user can propose a transaction based on a displayed perfect match, i.e., where the first user is offering all of the items sought by the second user, and where the first user is seeking to obtain at least one of the items offered by the second user. The second user can also include an offer to make a cash payment as part of the proposed transaction.

As part of the proposed transaction, the second user requests one or more swap items that are being offered by the first user, and offers the first user one or more swap items in exchange. The second user selects the requested swap items from the matching second sought items, and selects the offered swap items from the matching second offered items. In one implementation, the second user is allowed to view all the first offered items, and selects the requested swap items from the first offered items. In an alternative implementation, the requested swap items include one or more of the second offered items regardless of whether they are included in the matching second offered items. In one implementation, the second user includes a cash payment as part of the second offered items. The second user can also offer a cash payment in addition to the offered swap items as part of the proposed transaction. In one implementation, the second user specifies a preferred shipping method as part of the proposed transaction.

The proposed transaction is transmitted to the first user (step 210). In one implementation the proposed transaction is transmitted to the first user as an email message offering to exchange the requested swap items for the offered swap items. If the first user accepts the exchange offer (“yes” branch of decision step 215), the exchange transaction is completed (step 235). As part of completing the exchange transaction, the first user sends cash payments required for the proposed transaction to the second user using a secure payment protocol, e.g., PayPal, and notifies the second user that the proposed transaction is complete.

If the first user does not accept the exchange offer (“no” branch of decision step 215), the first user can propose a counter-offer (“yes” branch of decision step 220). As part of the counter-offer the first user modifies at least one of the requested swap items or the offered swap items. The first user can also add a cash payment from the first user to the requested swap items, or request a cash payment from the second user to the offered swap items. If the second user accepts the counter-offer (“yes” branch of decision step 225), the transaction is completed (step 235). As part of completing the exchange transaction, the second user sends cash payments required by the counter-offer to the first user using a secure payment protocol, e.g., PayPal, and notifies the first user that the proposed transaction is complete.

If the first user does not accept the exchange offer and does not propose a counter-offer (“no” branch of decision step 220), there is no exchange between the two users (step 230). If the second user does not accept the counter-offer (“no” branch of decision step 225), there is no exchange between the two users (step 230).

In accordance with one embodiment, the process begins with a user going online at a remote computer terminal, and through the Internet accessing the web site of the barter system in accordance with an aspect of the present method and system. This will take the user to a system home page. While a general, informational type search of items available for swap can be accessed from the home page, it is to be understood that to use the system, a party must first log on. This requires the entry of the user's name and password into data entry windows provided on screen. New users will be required to register, providing certain, minimal information including, for example, full name, post office address, e-mail address, and the like. As part of the initial registration process, the terms and conditions for using the site will be displayed, such terms and conditions governing the protocols for establishing a legally binding contract with other users as part of the barter/swap process. This is established using an “I accept” radio button. In one implementations as part of the sign up process, users are required to accept as a condition of using the system that any offer they post will be legally binding for a period of 72 hours.

Upon sign-in, the user will be taken by the system to his/her personal site page. Here, users can add or manage the items they are offering and seeking and update their account information. Users can also track feedback or enter feedback on completed transactions with other users. On their home page, uses can list items or services they are offering or seeking, and add or delete items sought or offered. They can choose to accept a swap in return, cash only or a combination of both. They can list the value they place on the item or service, or allow the other user to determine what it is worth to them through the “Make Me an Offer” option. If a user is only interested in a cash sale, they can select the “Instant Purchase” option, therefore bypassing the negotiation stage and allowing the other party to make a direct purchase for the listed price.

The home page of the user will display items being offered, and items being sought. Provision is also made for addition of new items the user wishes to offer for barter, and new items being sought. In this manner a user can create a list of multiple items offered and sought for swap at substantially the same time, all of which information is stored in the centralized database supporting the on-line web site.

When deciding to add an item to the list of items a user is offering (an “I have” type of item), or an item the user is seeking (an “I want” type of item), the user is taken to a new screen, where he is queried regarding specifics of the item to be offered or sought. After completing the entries that describe the exact item, the condition of the item, etc, the posting user is then queried as to the type of exchange desired. Here the user is provided with several choices. The user can opt to “swap only.” They can also select “swap/cash” (whereby they agree to swap an item for another item or for cash). Or, they can select “cash” (if they wish to accept cash only). If the latter is selected, the user must then set the price in the on-screen box provided. Alternatively, they can leave the price window blank by selecting the “make me an offer” feature. In the case of a service offered or sought, a different screen is provided for the user to complete, wherein information about the nature of the service is detailed, the user given the same choices with respect to swap only, swap/cash or cash only.

The user may also select the Instant Purchase feature, which allows the parties to skip the swap negotiation, and a third party to buy the item for the specified amount. Selecting this option is considered an agreement to sell the item at the listed price, and the selling user will be expected to complete the PayPal™ transaction as part of the process as outlined in the user agreement, which the user accepted as part of the sign up process.

Once the details of the items to be offered or sought are completed, the user may then at their option, add a photo or preview the listing by selecting the appropriate on screen radio button, and following the prompts provided on the next screen displayed. If the user is satisfied with the information provided, they then click on the “submit” button, which will send the completed information package to the central system site server where the data will be electronically stored as part of the users personal site data.

Users can utilize a simple keyword search to find items or they can use the advanced search functionality of the Intelligent Double Matrix (IDM) search program. When using the advanced features, users can place a geographic or other limitation on their search, and/or enter both the item(s) they are offering and the item(s) they are seeking. In one implementation, the results display perfect matches, as well as lists of all users who have the item they are seeking, and all those seeking the item they are offering. The perfect matches include lists of all users that have both the items that are being sought and the items that are being offered. In one implementation, the results display the perfect matches first before displaying the other matches.

Once a user has found an item or service they want, they may use the “Swap Wizard” to propose a transaction. The wizard allows the user to select any number of items and services from either party and add cash to either side. When the other party receives the offer they can accept it, make a counter offer or reject it. An exception to this process relates to items or services listed with the Instant Purchase option selected, in which case if the user enters the listed price, the sale is made instantly and no negotiations are necessary.

To complete the transaction a user who accepts the swap must complete a secure payment protocol to pay the transaction fee. In one implementation, all payment is completed via PayPal™ (an eBay company product), which has a wide adoption rate and limits the security risk for the system.

Once the transaction is completed, each user is prompted to provide feedback on the specific transaction with the other user. Feedback can be positive, negative or neutral and contributes to each user's overall score. Feedback is an integrated part of the system, which allows users to build trust and reputation within the system's community of users. In one embodiment, the rating system involves the assignment of a letter grade of A, B, C, D, or F, which is translated into a Swap Point Average (SPA), calculated the same as a traditional Grade Point Average.)

In accordance with one method of operation, a small, flat fee, such as $1.00 is charged per transaction when swapping items and/or items for cash. The same fee will apply regardless of the value of the item. Fees for services in accordance with another embodiment will be set higher, as the party offering a service will be obtaining additional value, that is, the introduction to a potential ongoing business relationship. In situations where an item is being swapped for a service, each party will pay to the system provider the applicable fee associated with what they are offering. With Instant Purchase, or any other trade that is cash only, the buyer will not be charged a transaction fee, and the item owners and service providers will for example be charged $1 and $10 respectively, regardless of value.

In another embodiment of the present method and system, when the systems' transactions exceed a certain threshold, say 500,000 transactions a month, the price per transaction may be increased, for example, to $1.50 to each party when swapping items (or items plus cash) and $15.00 to each party when swapping services (or services plus cash). As was the case with the first alternative, in situations where an item is swapped for a service, each party will pay the applicable fees associated with what they are offering. Users will be charged $0.25 to list an item or service they are offering, while listings for items or services they are seeking will remain free of charge. In another embodiment, transaction fees for Instant Purchase need not be a flat rate, but may bet set based on a percentage of the sales price. There would be no transaction fee for the users doing the purchasing, but the item owners and service providers would be charged an escalating fee based on the value of the transaction.

In yet another embodiment, as the use of the system further increases, such as to more than 1 million transactions a month, charges can be increased still further, as for example to $2 per party when swapping items (or items plus cash), and $20 per party when swapping services (or services plus cash). The fee for listing an item or service can also be increased, such as for example to $0.30 an item or service the user is offering for swap transactions, while listings for items or services they are seeking will still remain free of charge. The basis for incrementing prices based on the number of transactions per month is that the on line swap system brings greater value to the users as it matures, and gains wider acceptance, as measured by the increase in the number of site visits per month.

In another embodiment of the on-line system, Non profit companies can register and establish a site page for listing various items they need. For matches where requested items are donated, the exchange can be set up to be processed without a fee. The non profit entity can then electronically issue a donation receipt in exchange for the goods delivered.

In yet another embodiment, a “Partners” category of users can be established, especially tailored for the small business user, where special promotional features may be offered. In one alternative, the system is set up so that there is no charge for becoming a system partner. However, to maintain that status, the Partner must list an average minimum of 100 items on their offering page, and have at least 12 items or services listed on their seeking page. Such Partners can put inventory on line for sale, as well as trade for other inventory. For example, a comic book store having multiple copies of a particular comic book may wish to trade one of their copies for another select comic book from another store that has the desired item in stock. Such Non profits and Partners are assigned their own special identifier, which is made part of their site record.

In another embodiment, users are grouped into one or more Affinity groups. A affinity group is a group of individuals that share a common interest, e.g., a particular activity, locality, or community. Membership in an affinity group is by invitation only. In one implementation, each affinity group has a designated owner, e.g., an administrator, and the owner of the affinity group controls membership in the affinity group by approving or rejecting new members. The affinity group administrator can create subgroups within the affinity group. In one example, an affinity group for a national organization has one or more smaller sub-groups associated with each regional chapter or division.

Affinity groups are used to create small groups of member having a common interest. Members of an affinity group have a greater trust in other members of the affinity group, and may prefer to swap with the other members rather than users that not members. Affinity groups also help to reduce fraud, as members that do follow societal norms, or guidelines set by the group, are ejected from the group. In one implementation, the members of an affinity group are offered membership incentives for trading with other members of the affinity group. Membership incentives include, a discount or reduced shipping fees for trading with other members of the affinity group, free shipping insurance for trading with other members of the affinity group, and a revenue sharing program where a portion of the revenue collected for swap transactions within the affinity group is distributed to the administrator of the affinity group and optionally the members of the affinity group.

A user can be a member of more than one affinity group, and more than one sub-circle. In addition, the user can specify whether membership in the affinity group is public or private. If the user's membership in the affinity group is public, any user of the system can view user's affinity group membership, e.g., by viewing the user's profile on the system. If the user's affinity group membership is private, only other members of the affinity group can view the user's affinity group membership.

In one implementation, the displayed search results identify the affinity groups and sub-groups associated with each match. In one example, a user is a member of an affinity group for trading Atlanta baseball cards, the Atlanta Baseball Card affinity group. The user performs a search for a desired baseball card, and receives 10 search results. For three of the search results, the desired card is being offered by another member of the Atlanta Baseball Card affinity group. These three results are identified as being associated with the Atlanta Baseball Card affinity group, when the search results are displayed. In one implementation, the user views all the search results and selects a match associated with the user's affinity group to complete the swap transaction. In an alternative implementation, the user can specify that only matches in user-specified affinity groups be displayed, and the displayed search results only include matches associated with the user-specified affinity groups.

In another commercial application, users of the system can be allowed reduced transaction fees by purchasing the right to conduct a number of transactions (e.g. 10) for a fixed fee. Such purchase bundles are stored with the information regarding the purchasing user's personal swap site, and decremented each time a transaction is completed.

From time to time, to encourage usage of the system, coupons may be issued by the site provider on a global basis to an indefinite number of people. These coupons will allow these individuals to either conduct a transaction for free, or to conduct several transactions at a reduced price. The use of a coupon can be entered manually into the system along with the other stored information regarding the registered user, and the discount provided by the coupon applied to the next or next series of transactions of that user.

The systems architecture is designed to handle high transaction volumes and support a synchronous execution model. The system architecture is aligned with Java 2 Enterprise Edition (J2EE) supporting EJB 2.0 specification. The system architecture utilizes the standard MVC design pattern, thereby partitioning data presentation (the front-end), data representation and business logic into distinct entities. The J2EE programming model anticipates growth, encourages component-oriented code reusability and leverages the strengths of inter-tier communication. It is the tier integration that lies at the heart of the J2EE programming model.

The search engine will not only match what the search user is seeking, but will identify another customer who is seeking something that the searcher has for swap—the IDM “perfect match”. Once such a result is identified, the second user will be notified by email that a system user wishes to swap with them for a particular item in their swap list and has an item they are seeking. This artificial Intelligence-like component will implement complex algorithms and XML-depositor Xqueries (a type of computer code running the back end) to determine the result set, which is displayed to the querying user. The search engine also has the ability to return a simple result of a list of users who have a particular item for swap that was searched for, regardless of a successful IDM “perfect match.”

The system provides for search of items in the provided supplied database, under the Advanced Search feature. The feature is accessed by a button that appears on the left, navigation side of each page of the displayed web page. Here, the user is prompted to enter keywords from the items they are offering or seeking into the information window displayed. They can select from an on screen provided menu to find either “all the words,” “any of the words” or “the exact phrase.” When the user clicks the submit button, it triggers a database query for the specified criteria using the appropriate search logic depending on the selected criteria. Perfect Matches are sought if both offering and seeking text fields contain content when the query is initiated. To find Perfect Matches, the database IDM logic queries all item records with the specified criteria an any field that also meets the specified “seeking” and “offering” item record type criteria.

Keyword search results are reported as tabbed files in at least the following order: (1) “Perfect Match” tab (from both “Items I'm Offering”, and “Items I'm Seeking” criteria, combined; (2) “They Have It” tab (from “items I'm Seeking” criteria”), (3) “They Want It” tab (from “Items I'm Offering” criteria), and (4) “Donate It” tab (items being sought by a Non-profit (from I'm Offering” criteria). The tabs are displayed on the user screen from left to right in the order above. By default, the Advanced Search Results opens to the Perfect Match tab, unless there are no Perfect Matches found. If no Perfect Matches, then the Advanced Search Results opens to the tab that contains the greatest number of entries.

In accordance with another aspect of the present method and system, the system includes an insurance feature in which a user may purchase insurance on a transaction-by-transaction basis to cover up to the full value of the transaction. This is set up to be done online. Insurance is an optional service the user can choose to purchase at the time he is completing the transaction. At least two types of insurance are available. The first is insurance on the swap transaction itself and covers the user in case of misrepresentation or fraud on the part of the other user. This form of insurance if provided to cover the situation where the item is never sent or if sent, the item turns out not to be what the user claimed it to be. Users would be encouraged to resolve differences between themselves, and if the resolution was unsatisfactory, they could then submit the claim to the insurance company. The second type of available insurance is shipping insurance, which covers damage or loss during shipment of the item. This insurance will be offered through partner carriers such as UPS and USPS.

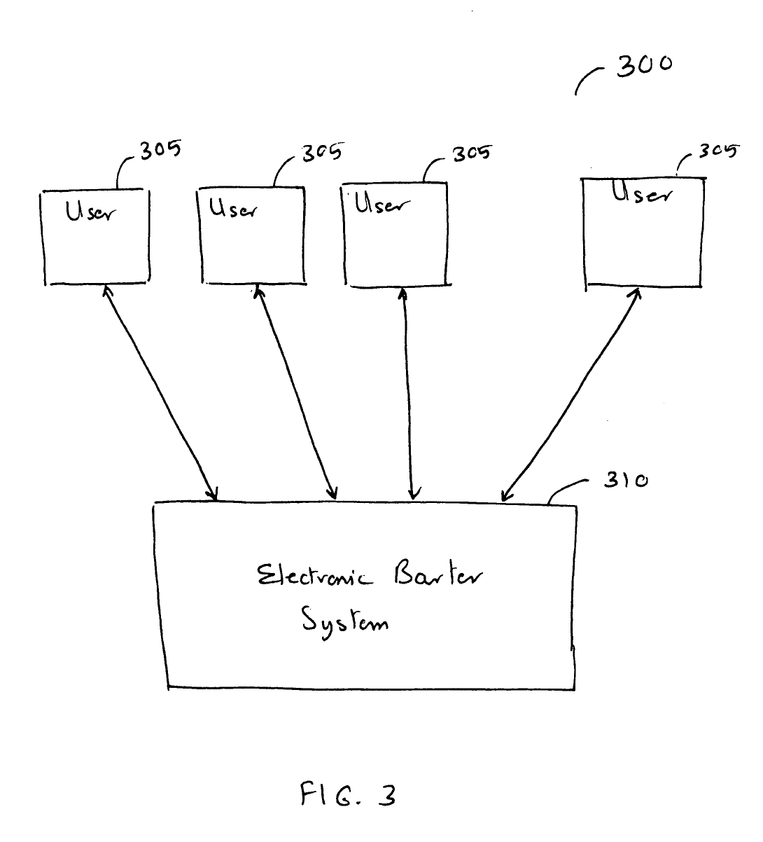

FIG. 3 illustrates an electronic barter system 310 that is connected to one or more users 305 using a computer network. The network can be a local area network (“LAN”), wide area network (“WAN”), virtual private network (“VPN”), or other network that is configured to transmit data among the users, and the electronic barter system. In one implementation the electronic barter system is implemented on a server and the users communicate with the electronic barter system using client computers that are connected to the server. The users can interact with the electronic barter system using by providing user input on a web page, and the electronic barter system can communicate with the users by displaying information on a web page that is displayed to the user. In addition, electronic mail (email) can also be used to communicate between the users and the electronic barter system.

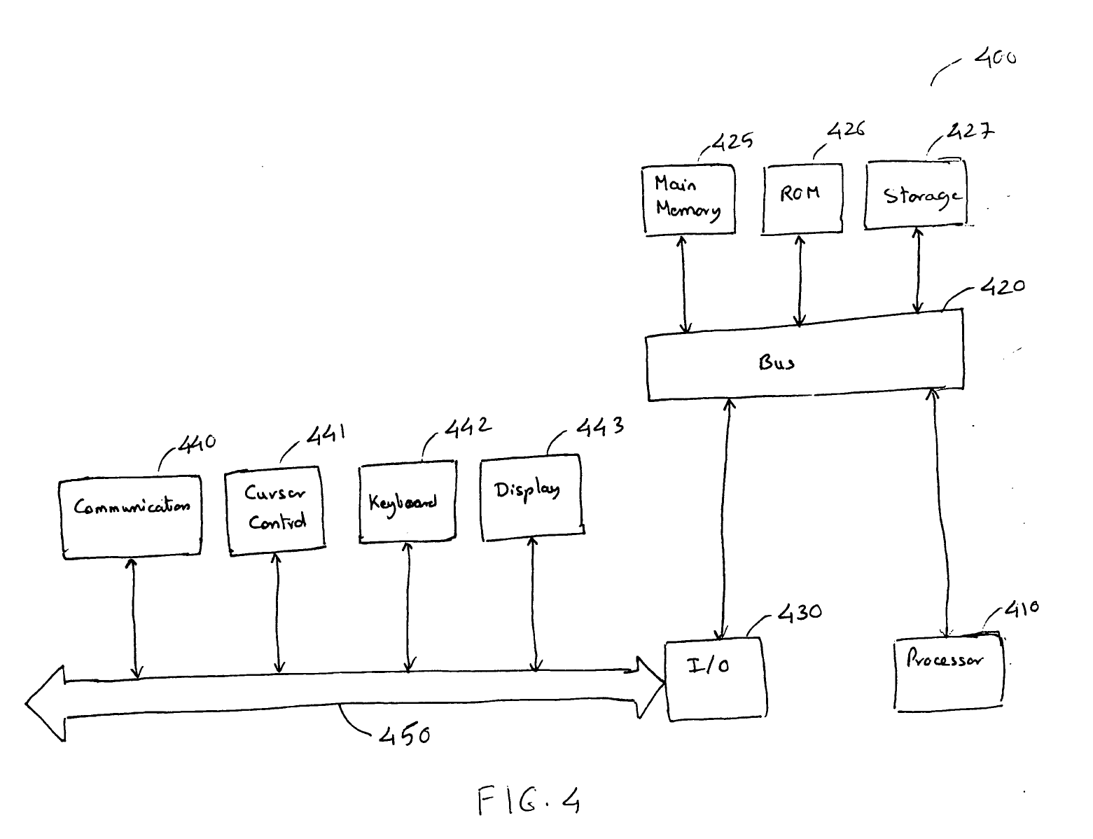

FIG. 4 illustrates an exemplary computer architecture for use with the present system, according to one embodiment. Computer architecture 400 can be used to implement the user machines 305, and the electronic barter system 310. One embodiment of architecture 400 comprises a system bus 420 for communicating information, and a processor 410 coupled to bus 420 for processing information. Architecture 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Architecture 400 also may include a read only memory (ROM) and/or other static storage device 426 coupled to bus 420 for storing static information and instructions used by processor 410.

A data storage device 427 such as a magnetic disk or optical disc and its corresponding drive may also be coupled to computer system 400 for storing information and instructions. Architecture 400 can also be coupled to a second I/O bus 450 via an I/O interface 430. A plurality of I/O devices may be coupled to I/O bus 450, including a display device 443, an input device (e.g., an alphanumeric input device 442 and/or a cursor control device 441). For example, web pages and business related information may be presented to the user on the display device 443.

The communication device 440 is for accessing other computers (servers or clients) via a network. The communication device 440 may comprise a modem, a network interface card, a wireless network interface or other well known interface device, such as those used for coupling to Ethernet, token ring, or other types of networks.

While the foregoing is directed to embodiments of the present method and system, other and further embodiments of the present method and system may be devised without departing from the basic scope thereof, and the scope thereof is determined by the claims that follow.

1. A computer implemented method comprising:
receiving user input from a first user, the first user input specifying one or more first offered items that the first user is offering to trade, the first user input further specifying one or more first sought items the first user is seeking to obtain in exchange for one or more of the first offered items;
receiving user input from a second user, the second user input specifying one or more second sought items that the second user is seeking to obtain, the second user further specifying one or more second offered items that the second user is offering in exchange for one or more of the second sought items;
performing a search operation in response to a search request from the second user, the search operation evaluating a match based on the second sought items, the second offered items, the first offered items, and the first sought items; and
displaying a result of the search operation to the second user, the displayed search results including matching second sought items and matching second offered items, the matching second sought items being one or more of the second sought items that the first user is offering to trade, the matching second offered items being one or more of the second offered items that the first user is seeking to obtain.

2. The method of claim 1, wherein the result of the search operation is displayed to the second user as a web page.

3. The method of claim 1, further comprising:
receiving a proposed transaction from the second user, the proposed transaction specifying one or more requested swap items in exchange for one or more offered swap items, the requested swap items comprising one or more of the matching second sought items, the offered swap items comprising one or more of the matching second offered items; and
transmitting an offer to the first user from the second user, the transmitted offer being an offer to exchange the requested swap items for the offered swap items.

4. The method of claim 3, wherein the requested swap items comprises the first offered items.

5. The method of claim 3, wherein the offered swap items comprises the first sought items.

6. The method of claim 3, wherein the offered swap items comprises a second cash payment from the second user.

7. The method of claim 3, further comprising:
completing the proposed transaction in response to receiving input from the first user accepting the offer.

8. The method of claim 7, wherein completing the proposed transaction comprises:
completing the transaction using a secure payment protocol.

9. The method of claim 7, wherein completing the offer further comprises:
modifying the proposed transaction in response to user input received from the first user proposing a counter-offer, the counter-offer specifying at least one modification to either the requested swap items or the offered swap items; and
transmitting a counter-offer to the second user from the first user, the transmitted counter-offer being an offer to exchange the modified requested swap items for the modified offered swap items.

10. The method of claim 9, wherein the modified requested swap items comprises a first cash payment from the first user, and the modified offered swap items comprises a third cash payment requested from the second user.

11. The method of claim 7, wherein completing the offer further comprises:
completing the proposed transaction in response to receiving input from the second user accepting the counter-offer.

12. The method of claim 1, displaying the result of a search operation comprises displaying search results in three categories, a first category displaying a perfect match, a second category displaying matching second sought items, and a third category displaying matching second offered items.

13. The method of claim 12, wherein displaying the search results comprises displaying the first category, the second category, and the third category in descending order.

14. The method of claim 12, wherein displaying the search results comprises displaying the three categories on the same web page or on three separate tabbed web pages.

15. The method of claim 3, wherein the second user is a member of one or more membership groups, and the displayed search results indicates whether the first user is a member of the membership groups.

16. A computer implemented method comprising:
receiving user input from a first user, the first user input specifying one or more first offered items that the first user is offering to trade;
receiving user input from a second user, the second user input specifying one or more second sought items that the second user is seeking to obtain, the second user further specifying one or more second offered items that the second user is offering in exchange for one or more of the second sought items;
performing a search operation in response to a search request from the second user, the search operation evaluating a match based on the second sought items, the second offered items, and the first offered items; and
displaying a result of the search operation to the second user, the displayed search results including matching second sought items, the matching second sought items being one or more of the second sought items that the first user is offering to trade.

17. The method of claim 16, further comprising:
receiving a proposed transaction from the second user, the proposed transaction specifying one or more requested swap items in exchange for one or more offered swap items, the requested swap items comprising one or more of the matching second sought items, the offered swap items comprising one or more of the second offered items; and
transmitting an offer to the first user from the second user, the transmitted offer being an offer to exchange the requested swap items for the offered swap items.

18. A computer program product tangibly embodied in a computer readable medium, the computer program product comprising instructions operable to cause a data processing equipment to:
receive user input from a first user, the first user input specifying one or more first offered items that the first user is offering to trade, the first user input further specifying one or more first sought items the first user is seeking to obtain in exchange for one or more of the first offered items;
receive user input from a second user, the second user input specifying one or more second sought items that the second user is seeking to obtain, the second user further specifying one or more second offered items that the second user is offering in exchange for one or more of the second sought items;
perform a search operation in response to a search request from the second user, the search operation evaluating a match based on the second sought items, the second offered items, the first offered items, and the first sought items; and
display a result of the search operation to the second user, the displayed search results including matching second sought items and matching second offered items, the matching second sought items being one or more of the second sought items that the first user is offering to trade, the matching second offered items being one or more of the second offered items that the first user is seeking to obtain.

19. The computer program product of claim 18, further comprising instructions operable to cause the data processing equipment to:
receive a proposed transaction from the second user, the proposed transaction specifying one or more requested swap items in exchange for one or more offered swap items, the requested swap items comprising one or more of the matching second sought items, the offered swap items comprising one or more of the matching second offered items; and
transmit an offer to the first user from the second user, the transmitted offer being an offer to exchange the requested swap items for the offered swap items.

20. A system comprising:
means for receiving user input from a first user, the first user input specifying one or more first offered items that the first user is offering to trade, the first user input further specifying one or more first sought items the first user is seeking to obtain in exchange for one or more of the first offered items;
means for receiving user input from a second user, the second user input specifying one or more second sought items that the second user is seeking to obtain, the second user further specifying one or more second offered items that the second user is offering in exchange for one or more of the second sought items;
means for performing a search operation in response to a search request from the second user, the search operation evaluating a match based on the second sought items, the second offered items, the first offered items, and the first sought items; and
means for displaying a result of the search operation to the second user, the displayed search results including matching second sought items and matching second offered items, the matching second sought items being one or more of the second sought items that the first user is offering to trade, the matching second offered items being one or more of the second offered items that the first user is seeking to obtain.

21. The system of claim 20, further comprising:
means for receiving a proposed transaction from the second user, the proposed transaction specifying one or more requested swap items in exchange for one or more offered swap items, the requested swap items comprising one or more of the matching second sought items, the offered swap items comprising one or more of the matching second offered items; and
means for transmitting an offer to the first user from the second user, the transmitted offer being an offer to exchange the requested swap items for the offered swap items.
